(19) United States
(12) Patent Application Publication
(10) Pub. No.: US 2002/0152137 A1
(43) Pub. Date: Oct. 17, 2002

(54) Drag-and-drop WEB site navigation system

(75) Inventors: Wesley D. Lindquist, Kansas City, MO (US); Albert P. Mauro, JR., Kansas City, MO (US); Beth A. Barrington, Prairie Village, KS (US); Erin C. Dennis, Parkville, MO (US); Lori A. Dickey, Leawood, KS (US); Michael C. Grundvig, Lenexa, KS (US); Patricia M. Lipnicky, Kansas City, MO (US); Scott R. Krouch, Gardner, KS (US)

Correspondence Address: PATTON BOGGS, PO BOX 270930, LOUISVILLE, CO, 80027, US

(73) Assignee: Hallmark Cards Incorporated

(21) Appl. No.: 09/834,466

(22) Filed: Apr. 13, 2001

(51) Int. Cl. G06F 17/60

(52) U.S. Cl. 705/27

(57) ABSTRACT

The drag-and-drop WEB site navigation system implements a drag-and-drop paradigm that allows customers to easily select WEB merchants from a plurality of WEB merchants, browse the merchant's products, select product(s) for purchase, select a recipient from the customer's personal address book to receive product and purchase the product. The customer can simply use the drag-and-drop mode of selection to perform each step of this process, to thereby minimize the use of the keyboard of the terminal device. In one embodiment of the system, the customer can access a centralized WEB site that has stored therein a profile of the customer's interests and/or the recipient's interests to thereby enable the customer to select WEB merchants from a list of customer/recipient preferences. The centralized WEB site can also maintain an address book for the customer, listing potential recipients for the purchases, as well as customer information to thereby eliminate the need to repetitively input information as the customer traverses a number of merchant's WEB sites and purchases products for multiple recipients.

### FIELD OF THE INVENTION

This invention relates to Internet e-commerce and to the software that provides a graphical user interface to enable the customer to browse a merchant's Internet WEB site and order products from the merchant's Internet WEB site.

### PROBLEM

It is a problem in the field of e-commerce to simplify the process of selecting and purchasing products from a merchant over the Internet. The basic architecture presently used in e-commerce requires that the customer connect their terminal device to a merchant's WEB site via the Internet. The customer's terminal device is equipped with a standard WEB browser that interconnects with the software that is resident on the merchant's WEB site and provides the graphical user interface to enable the customer to retrieve information from the merchant's WEB site. The merchant's WEB site is designed to include a plurality of display screens, which the customer can navigate seriatim to retrieve information about the products offered by the merchant via the merchant's WEB site.

The purchase of products via the merchant's WEB site entails the customer inputting a significant amount of data, primarily via the keyboard of the terminal device. The customer must typically input their name and address information (unless they have an existing account with the merchant) as well as name and address information for the recipient, identification of the product(s) to be purchased, entry of data that defines the mode of payment, and product delivery instructions. This process must be repeated for every merchant that the customer visits as well as for each recipient designated by the customer during the visit to the merchant's WEB site. The successive merchant visits entail the customer departing from a merchant's WEB site and then inputting the domain name of the next merchant's WEB site to be visited. This process is also subject to error with the amount of information that the customer must input.

Many improvements have been made over the past few years to simplify the e-commerce shopping process with the use of the shopping cart paradigm, “one-click shopping,” and the like. However, there is still a significant amount of data that the customer must manually input into each merchant's WEB site for each purchase for each recipient and there is no coordination of information among the various merchant's WEB sites. Thus, the purchase of products for a number of recipients and/or via a number of merchant's WEB sites entails the customer inputting a significant amount of data, primarily via the keyboard of the terminal device, for each merchant's WEB site visited.

### SOLUTION

The above described problems are solved and a technical advance achieved by the drag-and-drop WEB site navigation system which implements a drag-and-drop paradigm that allows customers to easily select WEB merchants from a plurality of WEB merchants, browse the merchant's products (including goods and services), select product(s) for purchase, select a recipient from the customer's personal address book to receive product and purchase the product. The customer can simply use the drag-and-drop mode of selection to perform each step of this process, to thereby minimize the use of the keyboard of the terminal device.

In one embodiment of the system, the customer can access a centralized WEB site that has stored therein a profile of the customer's interests and/or the recipient's interests to thereby enable the customer to select WEB merchants from a list of customer/recipient preferences. The centralized WEB site can also maintain an address book for the customer, listing potential recipients for the purchases, as well as customer information to thereby eliminate the need to repetitively input information as the customer traverses a number of merchant's WEB sites and purchases products for multiple recipients.

This drag-and-drop WEB site navigation system therefore provides the customer with an efficient and accurate mode of implementing e-commerce, in a single transaction with either a single vendor or multiple vendors and/or purchasing products for either a single recipient or multiple recipients.

As an alternative, the drag-and-drop WEB site navigation system can make use of an Interactive Voice Response (IVR) system that enables the customer to navigate through the centralized site, whether WEB-based or otherwise, to browse the merchant's products (including goods and services), select product(s) for purchase, select a recipient from the customer's personal address book to receive product and purchase the product. The customer can simply use the drag-and-drop mode of selection, in a voice activated form, to perform each step of this process, to thereby minimize the use of the keyboard of the customer's terminal device.

### BRIEF DESCRIPTION OF THE DRAWING

FIGS. 1A and 1B illustrate in block diagram form the overall architecture of the present drag-and-drop WEB site navigation system and a data communication environment in which it is operational;

FIGS. 2-5 illustrate in flow diagram form the operation of the present drag-and-drop WEB site navigation system; and

FIGS. 6-15 illustrate screen displays that are used by the present drag-and-drop WEB site navigation system to enable a customer to navigate through the system.

### DETAILED DESCRIPTION

### Customer Terminal Equipment and Communications Environment

The customers are typically equipped with one or more of a personal computer T1, hand held computing device T2, cellular communication device T3, wireless computer device T4, or other data interface device, collectively termed “terminal equipment” herein. The data communication connection between the customer's terminal equipment T1 and a fulfillment center 120 that hosts the present drag-and-drop WEB site navigation system 10 can be via the Internet 103, using the well known personal computer modem and Internet browser technology available at the customer's terminal equipment T1. The customer's terminal equipment is generally served by the Public Switched Telephone Network (PSTN) which consists of a plurality of Local Exchange Systems 101, 102 interconnected via an Inter-Exchange Carrier Network 100. The physical connection that supports this data communication connection is typically effected from customer's terminal equipment T1 through the Local Exchange System 102 of the Public Switched Telephone Network (PSTN) via a data communication medium (such as the Internet), termed IP Network 103 herein, to an Internet Service Provider 112 which is also connected thereto. The Internet 103 is also connected to a Local Exchange System 101 via Internet Service Provider 111 that serves the gateway 122 of the fulfillment center 120. Alternatively, the customer's terminal equipment, in the case of cellular communication device T3, or wireless computer device T4, is connected via the Mobile Telecommunications Switching Office (MTSO) 104 to the Public Switched Telephone Network (PSTN).

### Fulfillment Center

The fulfillment center 120 is connected to at least one data communication medium 103 (such as the Internet) to thereby enable customers to obtain data communication connections with the fulfillment center 120, as described in more detail below. The resources illustrated herein are selected for the purpose of illustrating the concept of the fulfillment center 120 and are not intended to limit the applicability of this concept to other network implementations. Fulfillment center 120 consists of a server 121 which is connected to the Internet 103 via a gateway 122 that comprises the firewall which protects the fulfillment center 120 from unauthorized access and also implements the functionality to communicate with Internet Service Provider 111. The fulfillment center 120 includes a message system 122A that is used to generate and transmit e-mail messages to customers and to also transmit any electronic messages and/or data transmissions that are generated by the fulfillment center 120 to the designated recipient.

### Architecture of the Drag-and-Drop WEB Site Navigation System

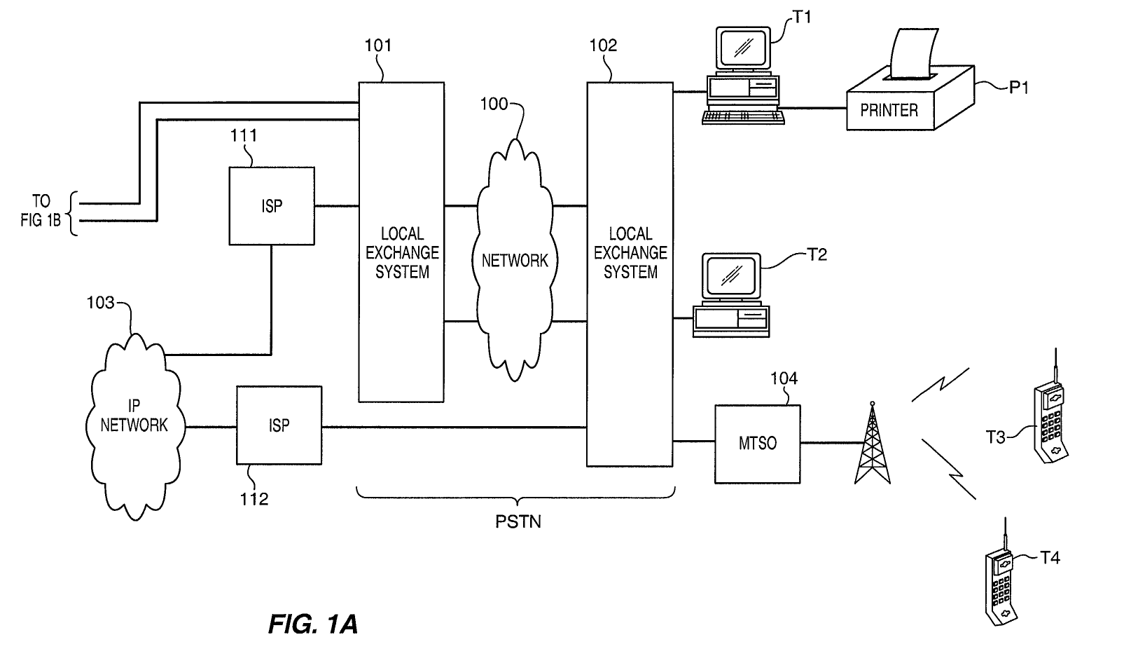

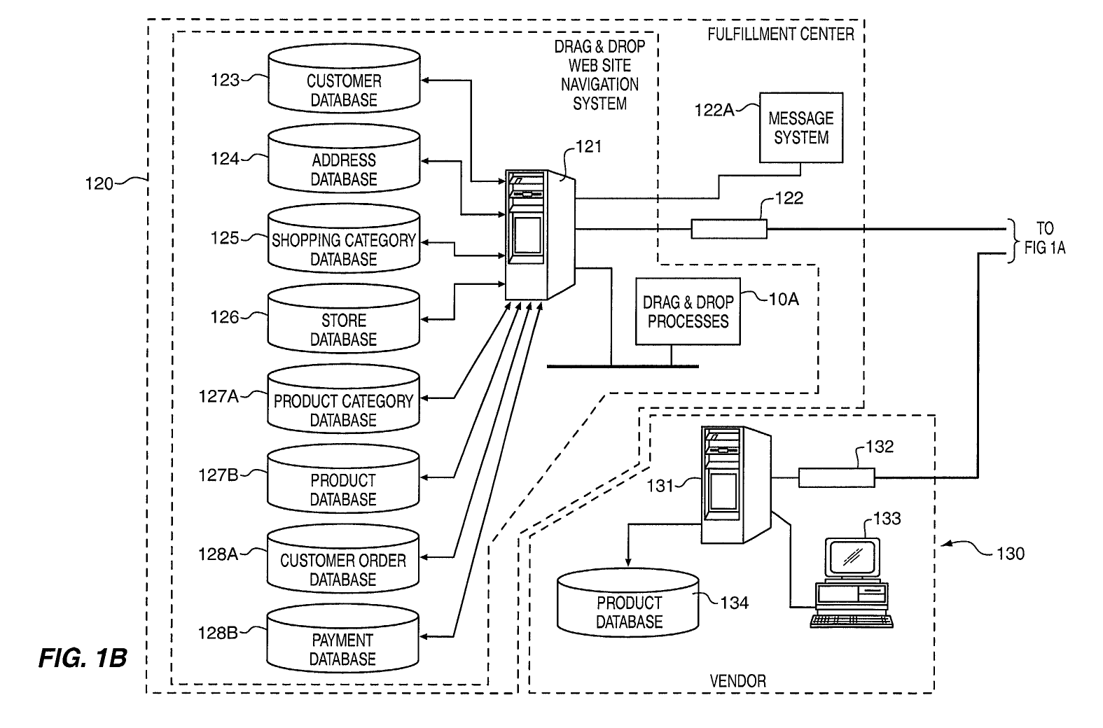

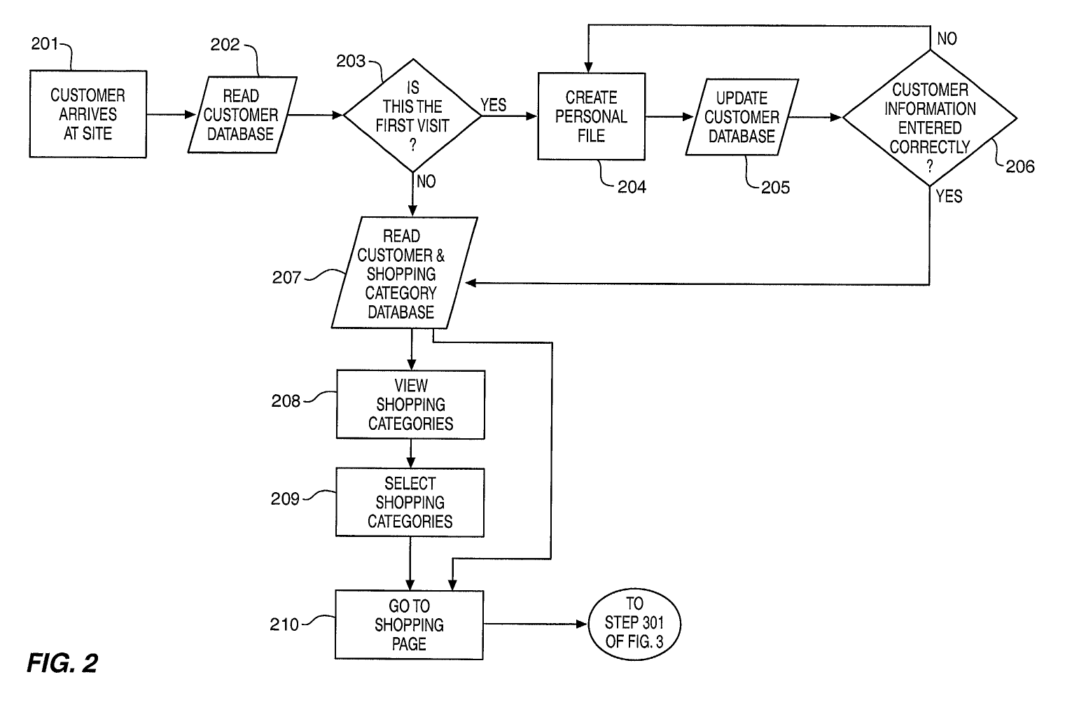

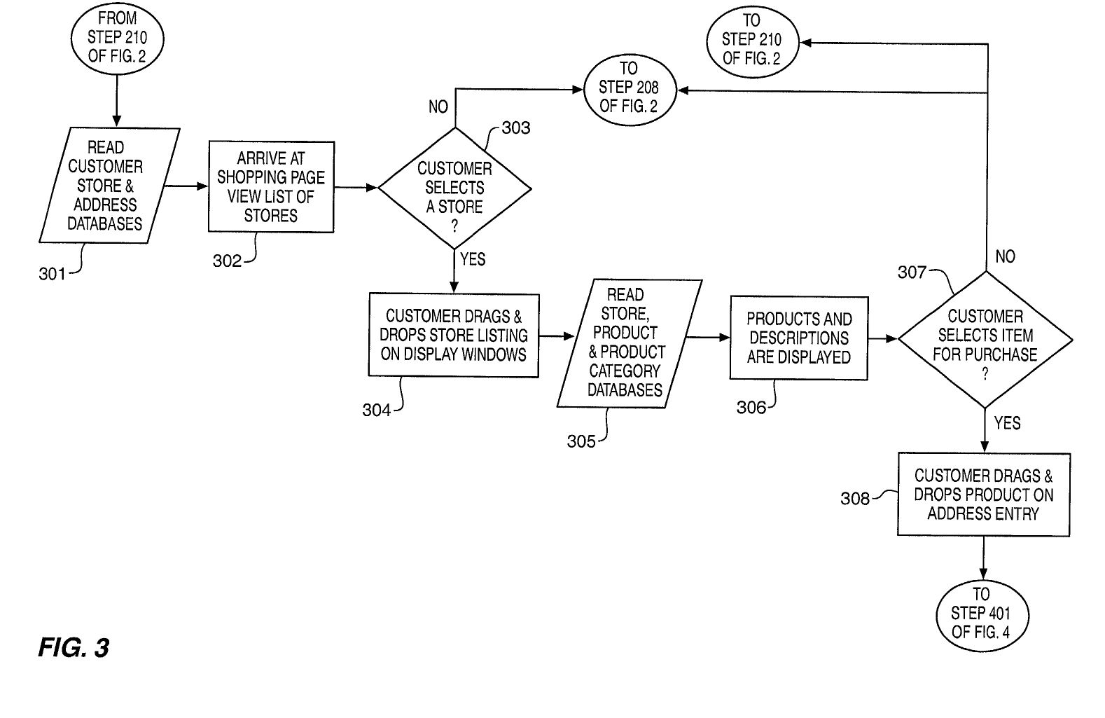

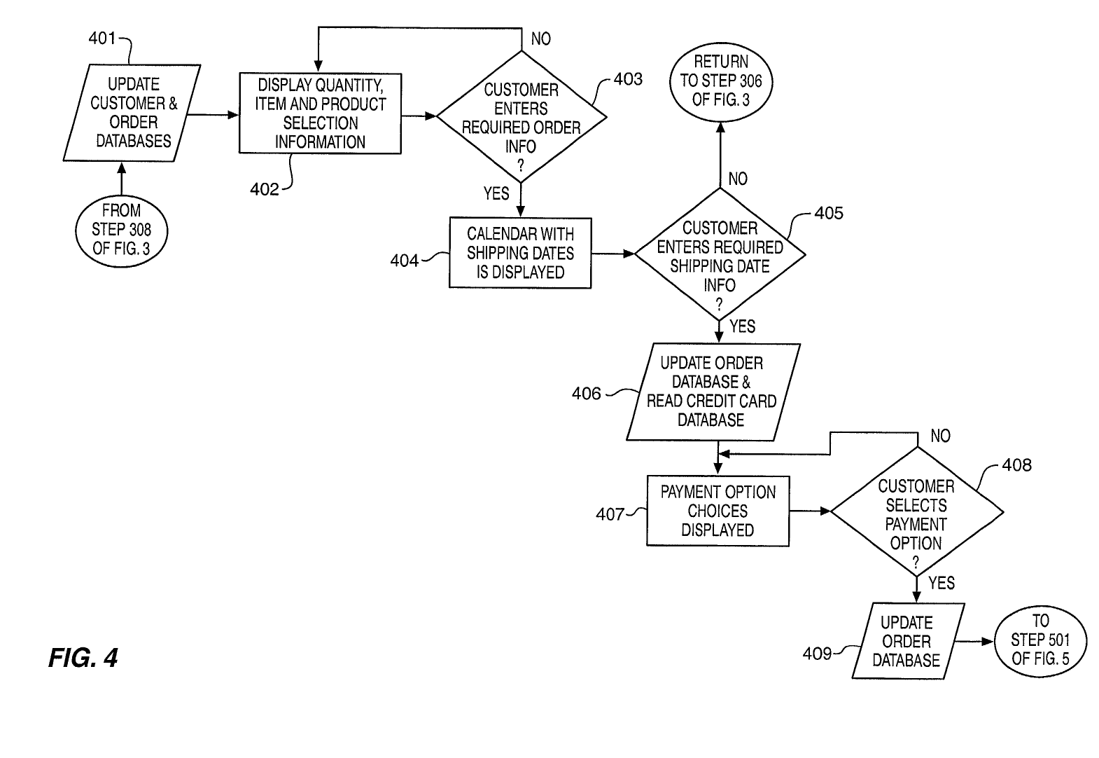

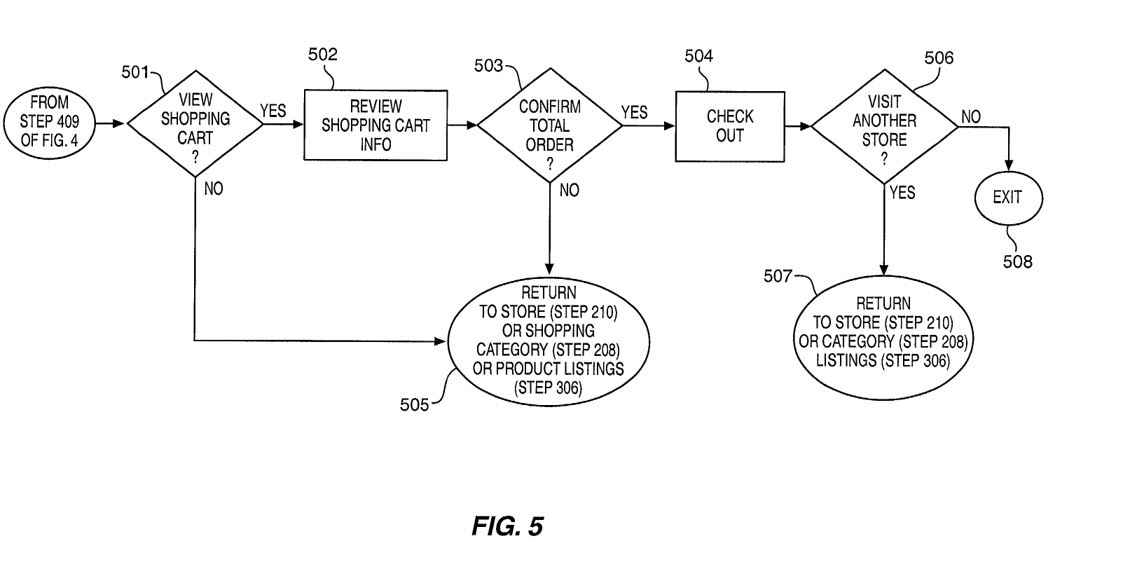

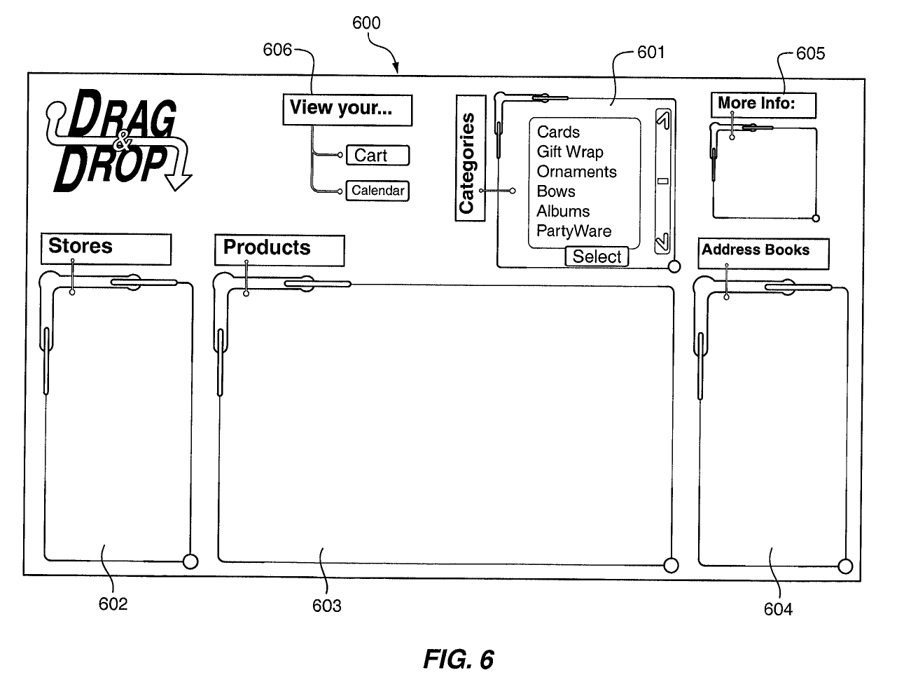

FIGS. 1A & 1B illustrate in block diagram form the overall architecture of the drag-and-drop WEB site navigation system 10 and a typical environment in which it is operational and FIGS. 2-5 illustrate in flow diagram form the operation of the present drag-and-drop WEB site navigation system. FIGS. 6-15 illustrate screen displays that are used by the present drag-and-drop WEB site navigation system 10 to enable a customer to navigate through the system. The architecture of the drag-and-drop WEB site navigation system 10 described herein represents a typical implementation of the drag-and-drop WEB site navigation system 10 and its operating environment and is not intended to limit the scope of the underlying concept as defined in the enclosed claims.

The drag-and-drop WEB site navigation system 10 is shown as being an integral part of the fulfillment center 120, although the drag-and-drop WEB site navigation system can also be a stand alone system that is connected, for example, to the Internet (IP Network) 103 and accessible to the fulfillment center 120 via the Internet (IP Network) 103, or drag-and-drop WEB site navigation system can also be a part of (or connected to) the customer's personal computer T1 or an extranet (Local Area Network) that serves the customer's personal computer T1.

In addition, the drag-and-drop WEB site navigation system 10, as shown, includes a set of control processes 10A, such as program instructions, that are used by processor 121 to access the data stored in a plurality of databases 123-128B and provide the functionality that is used to implement the communication session, such as the shopping session as described herein. The location and content of these databases can vary widely and the example used herein is selected for simplicity of description. In particular, the drag-and-drop WEB site navigation system 10 can reside on a server that is part of the fulfillment center 120 and the databases can reside on associated data storage subsystems that are part of the fulfillment center 120. However, some of the databases can reside elsewhere since the data that are stored therein may be maintained by others. For example, the product database that describes the products available from a particular vendor (also termed “store” herein) may reside on the fulfillment center 120 or can be located on a server 131 that is part of a vendor WEB site 130 that is located external to the fulfillment center 120 and maintained by the vendor. The vendor's server 131 and associated product database 134 can be accessed via a data communication session between the drag-and-drop WEB site navigation system 10, the vendor's gateway 132 and the vendor's server 131, as is described below. This access can be via a process, such as a predetermined script, that automatically queries the vendor's server 131 to retrieve only selected data from the product database 134 in order to minimize the data transfer between the vendor's server 131 and the drag-and-drop WEB site navigation system 10. In addition, the drag-and-drop WEB site navigation system 10 can be implemented to serve a single vendor and their products or can be implemented to serve multiple vendors. In the multiple vendor case, the data from one or more vendors can reside on fulfillment center 120 and data from other vendors can optionally reside on external sites, such as vendor's WEB site 130. Various combinations of data location, data sharing and the like can be included in a particular implementation of the drag-and-drop WEB site navigation system functionality.

There are many configurations of the drag-and-drop WEB site navigation system 10 that can be envisioned, and the embodiment disclosed herein simply represents one of these configurations that illustrate the concepts of the invention. In particular, the description envisions the use of existing components in the fulfillment center 120 to implement the disclosed functionality. The ability to use a voice-based interface in envisioned here, with the drag-and-drop WEB site navigation system 10 operating on a voice prompt basis rather than a graphical user prompt basis. Thus, the customer can vocalize their drag and drop selections rather than using a pointing device in the customer terminal equipment.

### Databases

The drag-and-drop WEB site navigation system 10 includes, in whole or in part or operates in conjunction with: the Customer Database 123, Address Database 124, Shopping Category Database 125, Store Database 126, Product Category Database 127A, Product Database 127B, Customer Order Database 128A, Payment Database 128B, and the like, in implementing the web store drag-and-drop site navigation functionality. The Customer Database 123 typically stores data that define the customer—customer name, password, account number, payment data, preferences, and the like. The Address Database 124 typically stores data that define the individuals that are the recipients of products purchased by the customers. The Address Database 124 typically stores data that define a name, mailing address, telephone number, associated customer(s), e-mail address, and the like. The Shopping Category Database 125 typically stores data that define the various categories of products that are provided by the various vendors that are served by the drag-and-drop WEB site navigation system 10 and the identity of the stores in each of these product categories. The stores listed in this database for this customer can be a predetermined selection of stores, or can represent a subset of the plurality of stores that is accessible to the subscriber, with the list being generated automatically by the drag and drop WEB site navigation system 10 based on a customer profile and/or as edited by the customer. The Store Database 126 typically stores data that define the stores served by the drag-and-drop WEB site navigation system 10 and parsing information that identifies the categories of products that each store includes in their product array, as well as store access information as described below. The Product Category Database 127A typically stores data that define the various sub-categories in a selected Product Category to refine the customer's search for a product. The Product Category Database 127A can be organized on a hierarchical basis to enable the customer to navigate through the hierarchy to a manageable group of products and can include a list of products for each product category. The Product Category can include various parsing parameters, such as price, availability, seasonal nature of the product, and the like. The Product Database 127B typically stores all of the data that relates to each product, including product descriptions, images, product specific ordering data, such as price, discounts, size, color, model number, and the like. The Customer Order Database 128A typically stores data that define the particular products ordered by a customer in a presently active shopping session. The order information typically includes customer name, recipient identification data, product data, delivery dates, shipping information, and the like. The Payment Database 128B typically stores data that indicates the payment options that the customer is authorized to use in purchasing products, including the specific data relating to a Payment purchase authorization session.

While these characterizations of the content and function of the various databases represent typical implementations, it is obvious that the number of databases and their contents are subject to implementation choices, including the selection of a location at which the particular database resides, whether on drag-and-drop WEB site navigation system 10 or some externally located server, or a combination of sites. In addition, the data stored in the various databases are typically linked to enable each database to perform a data management function that is focused on the type of data stored therein, but the data is linked across all of the databases on a customer basis to enable the customer to execute a shopping session in an efficient manner.

### Customer Login Interface

FIG. 2 illustrates in flow diagram form the operation of the drag-and-drop WEB site navigation system 10 to provide the initial customer login interaction. In well-known fashion, the customer, using terminal equipment T1, establishes a communication connection to the fulfillment center 120 via the IP Network 103 (Internet). The fulfillment center 120 at step 201, as part of the initial connection, presents the customer with a site login page (not shown) or an audible login greeting provided by an Interactive Voice Response (IVR) system (part of the gateway 122) as is well-known in the art. The customer inputs data in the requested data entry fields to identify the customer to the drag-and-drop WEB site navigation system 10. The graphical user interface presents a screen with a plurality of data entry fields, each of which represents a necessary or optional piece of data that is used to identify the customer and provide authenticated access to the drag-and-drop WEB site navigation system 10. In the Interactive Voice Response interface instance, the customer is provided with a series of audible prompts and the customer's audible response is decoded and used as the data entries that correspond to the data field entries used in the graphical user interface mode. The drag-and-drop WEB site navigation system 10 can provide access to the Interactive Voice Response (IVR) system as part of the Internet connection or as a separate voice communication connection

The drag-and-drop WEB site navigation system 10 at step 202 reads the existing Customer Database 123 and at step 203 determines from the login data provided by the customer whether this is the customer's first visit to the drag-and-drop WEB site navigation system 10. If so, processing advances to step 204 where the drag-and-drop WEB site navigation system 10 creates a personal profile for the customer. This is accomplished by providing the customer with a data entry screen that requests data from the customer to enable the drag-and-drop WEB site navigation system 10 to populate a profile for the customer. The customer is presented with a page (not shown) or an audible script that explains the functionality of the site, and allows the customer to personalize the selection and categories of stores the customer wishes to view as well as the operation of the drag-and-drop WEB site navigation system 10 in terms of the defaults and preferences assigned to this customer. In the Interactive Voice Response interface instance, the customer drag-and-drop WEB site navigation system 10 can provide a series or menu of choices to the subscriber and the customer's audible input provides the selections from the menu.

The customer is also allowed to create a personal address book and optionally enter preference data that indicates the shopping preferences of the customer and/or the various recipients listed in the customer's address book entries. The address book can be populated by uploading data from external sources, such as an address book resident on the customer's terminal equipment T1, or located at external sites and electronically accessible by the drag-and-drop WEB site navigation system 10. Once the customer has provided the requested data, at step 205 the drag-and-drop WEB site navigation system 10 updates the Customer Database 123 with this information. The drag-and-drop WEB site navigation system 10 also at step 206 determines whether the customer has correctly entered the requested data. If not, processing returns to step 204 where the customer is prompted to correct the erroneously entered or incomplete data entries. Once the customer has successfully completed the data entry, or this is not the customer's first visit to the drag-and-drop WEB site navigation system 10, processing advances to step 207 where the customer's identity is used to retrieve customer profile information from the Customer 123 and Shopping Category 125 Databases.

After the initial visit, the first page the customer sees at step 208 is typically the Shopping Page 600 (FIG. 6), which is a window divided into four main sections 601-604. The first section 601 contains a listing of Shopping Categories. The second section 602 displays a listing of the web stores the customer has selected during the shopping session, as described below. The third section 603 is for the display of product and product information. The fourth section 604 displays entries from the customer's address book, which entries may be filtered by the Shopping Category selected. Thus, the customer's address book may be large and to reduce the number of selections presented on the display, the address book entries are reduced to those for whom the customer has indicated a preference in the selected Shopping Category. Additional sections can optionally be provided, such as section 605 that enables the display of additional information relating to the present state of the shopping session, and section 606 that provides the customer with icons that enable site navigation, such as viewing the shopping cart to see what products have already been selected and/or ordered and a calendar for use in selecting a shipping date or to view data (such as reminders or occasions) relating to events that have been entered by the customer. In addition, icons or “quick keys” or voice input can be used to enable the customer to jump to a selected store rather than navigating the Shopping Category as described below.

### Shopping Page Display

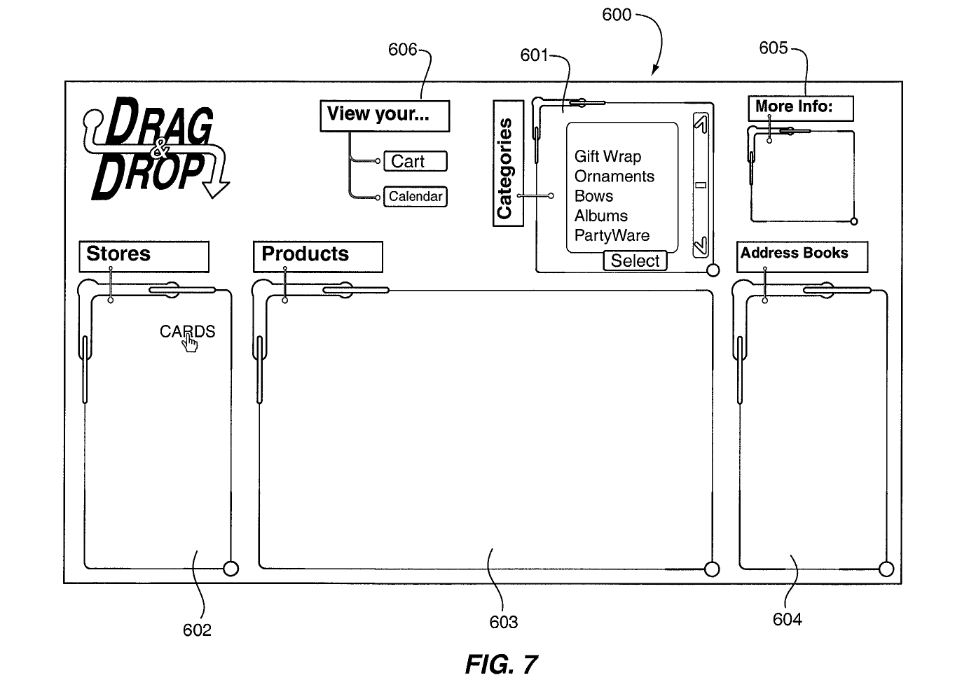

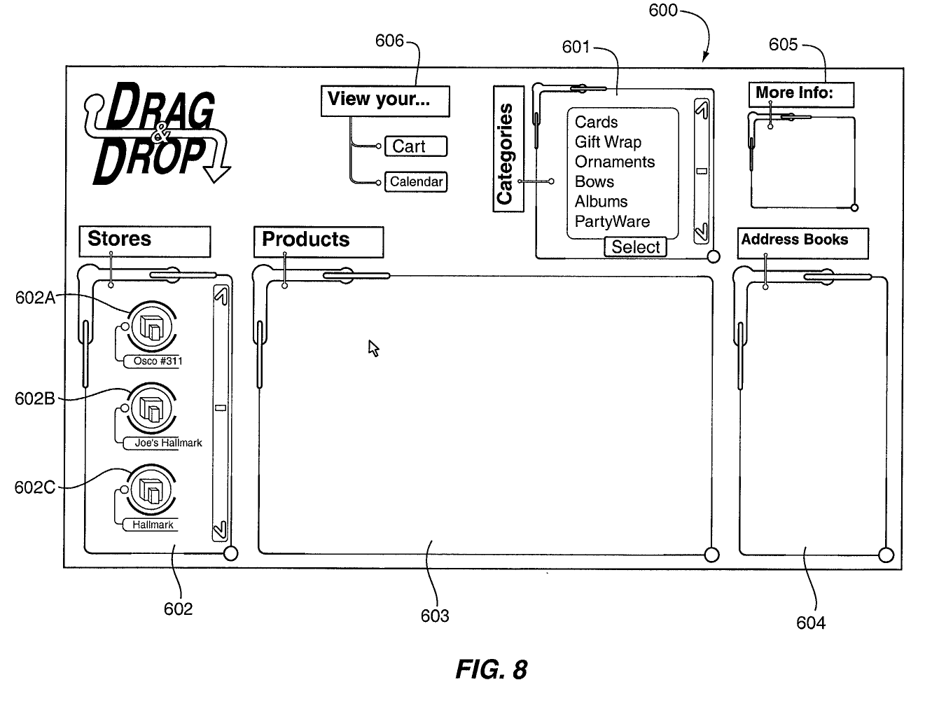

The customer is able to select the category of products he wishes to view at step 209 by clicking on an icon representative of a selected one of the displayed Shopping Categories, holding down the mouse button and dragging the icon representative of the selected Shopping Category (CARDS) to the store display portion 602 of the Shopping Page 600 display screen as shown in FIG. 7. In the Interactive Voice Response interface instance, the customer drag-and-drop WEB site navigation system 10 responds to the customer's audible selection that corresponds to the graphical user interface operation described above. After the customer has selected a Shopping Category, the drag-and-drop WEB site navigation system 10 advances to step 210 where the Shopping Page 600 is presented to the customer with store data displayed thereon as shown in FIG. 8. Alternatively, the customer can simply click on the “Stores” title of the stores display portion 602 of the Shopping Page 600 display or speak the title to activate the drag-and-drop WEB site navigation system 10 to advance to step 210 where the Shopping Page 600 is presented to the customer with store data displayed thereon as shown in FIG. 8. This store data can be a default stored in the Customer Database 123 or can simply be at least a portion of the entirety of the store data so the customer can directly select a store without executing the shopping category steps described above. In either case, the customer simply uses the graphical user interface functions of point, click, drag and drop (or audible input) to input data, make selections and execute the e-commerce shopping session.

The Shopping Page 600 is configured by the drag-and-drop WEB site navigation system 10 from data that is retrieved from the Customer 123, Store 126 and Address 124 Databases at step 301. Thus, the drag-and-drop WEB site navigation system 10 uses the customer profile data retrieved from the Customer Database 123 to identify at least one store, such as the stores that are represented by store icons 602A-C, listed in the Shopping Category Database 125 that the customer has shopped in or has indicated a preference to shop in.

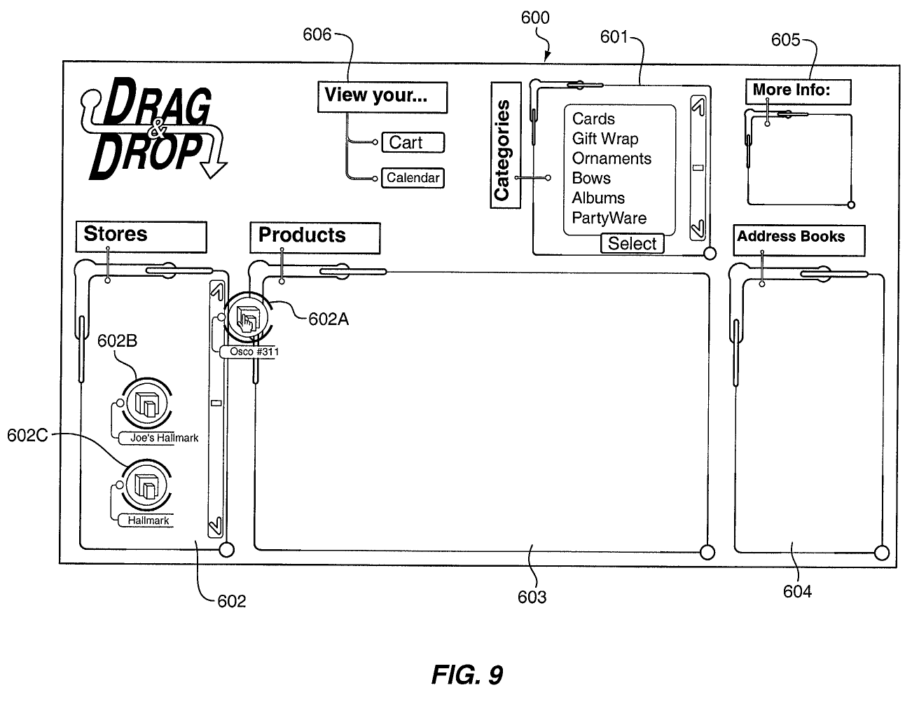

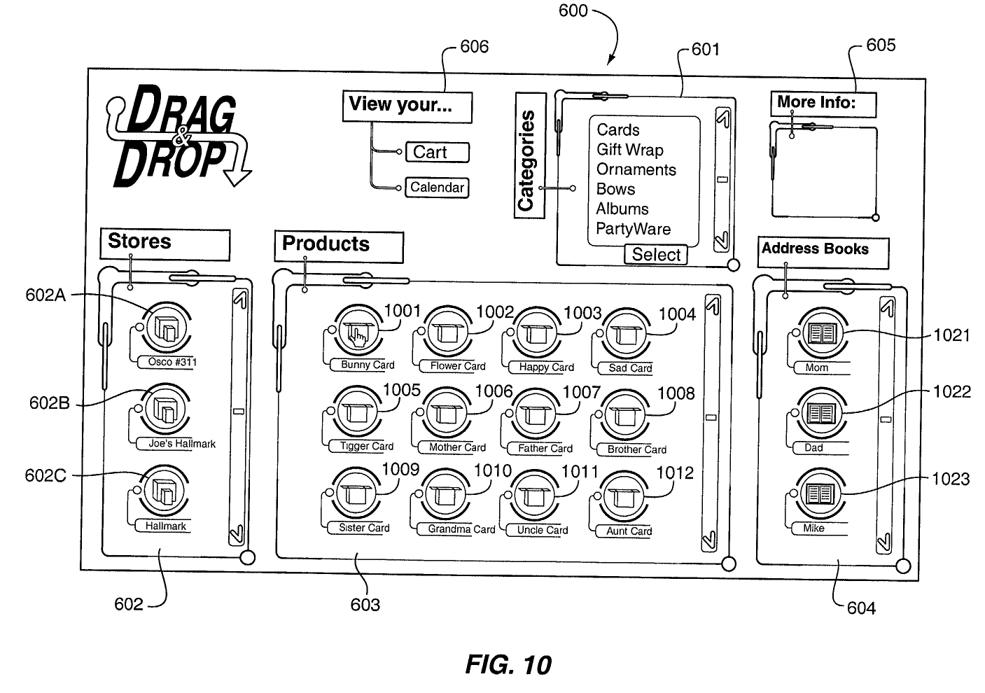

The customer is able to view a listing of stores on the Shopping Page 600 at step 302 and when the customer wishes to view a selected store's products, the customer clicks on the selected store's icon 602A at step 303, holds down the mouse button while dragging the selected store's icon 602A to the product display portion 603 of the Shopping Page 600 as shown in FIG. 9, and then releases the mouse button at step 304. In the Interactive Voice Response interface instance, the customer drag-and-drop WEB site navigation system 10 responds to the customer's spoken selection. The drag-and-drop WEB site navigation system 10 then retrieves data from the Store 126, Product Category 127A, and Product 127B Databases at step 305 to produce a display of the product categories and/or products (typically including pricing information) that are stocked by the selected store, as shown in FIG. 10. In order to identify the store that has been selected, the icon 602A for the selected store, even though the icon 602A returns to its original location, can be highlighted on the display. This store & product selection step may be implemented as two separate steps where the customer first selects a product category, then the drag-and-drop WEB site navigation system 10 only retrieves product data for that category from the Product Database 127B. In addition, the customer profile data is used to retrieve the recipient address data associated with this customer from the Address Database 124, and may filter the address data by the customer's profile data to reduce the number of entries displayed. For example, the customer may designate certain shopping categories for each of the recipients listed in the address book to simplify the shopping session. Each recipient selected from the Address Database 124 is displayed via an icon, such as icons 1021-1023, in the fourth section 604 of the Shopping Page 600 as described above.

The display of the products 1001-1012 and their associated descriptions at step 306 is customized based on the customer's selections of Product Category and Store, as well as by the products in this category that are stocked by the selected store. The customer's preferences as stored in the customer profile data can be used to filter the listing of products that is displayed, or the order of listing products can be varied by the customer profile, or the entirety of the product listing may be provided, as a function of the number of products in the Category. Therefore, the drag-and-drop WEB site navigation system 10 can perform a mapping function to parse the store inventory into appropriate categories, which are then retrieved as a function of the customer's selection. It is evident that additional filtering can be effected by the use of customer profile information that is stored in the customer database to thereby present the most likely products to the customer.

The location of the Product Database 127B can vary, with one instance the Product Database 127B being part of the fulfillment center 120 and another instance, the Product Database 134 residing on a data storage device served by the vendor's server 131. In the latter case, the drag-and-drop WEB site navigation system 10 can use the customer's data entry session to automatically create a script or other mechanism/process that is used to access the vendor's system 130 and associated Product Database 134. For example, the drag-and-drop WEB site navigation system 10 can establish a data communication connection via gateway 122 and Local Exchange System 101 via Internet Service Provider 111 to Internet 103 and thence via Internet Service Provider 111 and Local Exchange System 101 to Vendor Server System 130. The Vendor Server System 130 typically includes a gateway 132 and one or more terminal devices 133 for order and data entry. The drag-and-drop WEB site navigation system 10 can login in to this site and use the customer's data to retrieve product data from the vendor's Product Database 134. Thus, the drag-and-drop WEB site navigation system 10 functions as the customer's agent, automatically performing the browsing function on the Vendor Server System 130 for the customer. The browsing can also be simultaneously implemented on a plurality of vendor WEB sites, with the results being displayed either seriatim or concurrently on the third section of the Shopping Page. Furthermore, the Product Database could reside on a readable medium, such as a CD-ROM, the subscriber loads into a drive on the customer personal computer T1.

At step 307, the drag-and-drop WEB site navigation system 10 determines whether the customer has selected an item for purchase by monitoring the actions of the customer. The customer can elect to return to step 208 and select a different shopping category, or to step 303 to select a different store, or can return to step 306 to display additional product descriptions in the presently selected store. The selection of the Shopping Category or Stores or Product Categories or Products can be effected as described above by simply clicking on the appropriate icon and dragging it to the appropriate section of the Shopping Page 600 or clicking on the section title. In the Interactive Voice Response interface instance, the customer drag-and-drop WEB site navigation system 10 responds to the customer's audible input that corresponds to the above-described point, click, drag and drop operations.

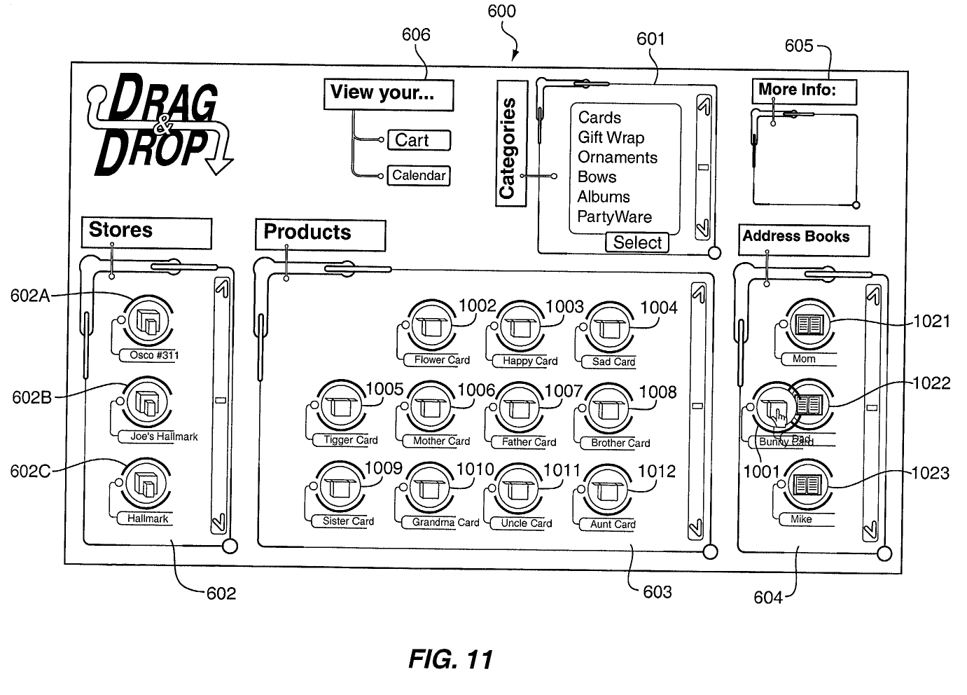

The customer selects an item for purchase at step 308 by selecting a displayed product icon 1001, holding down the mouse button, dragging the selected product icon 1001 to the fourth portion 604 of the Shopping Page screen 600 and dropping the product icon 1001 on an address entry 1022 that is displayed in the customer's address book, as shown in FIG. 11. In the Interactive Voice Response interface instance, the customer drag-and-drop WEB site navigation system 10 responds to the customer's audible input that corresponds to the above-described point, click, drag and drop operations.

### Product Selection and Shipment

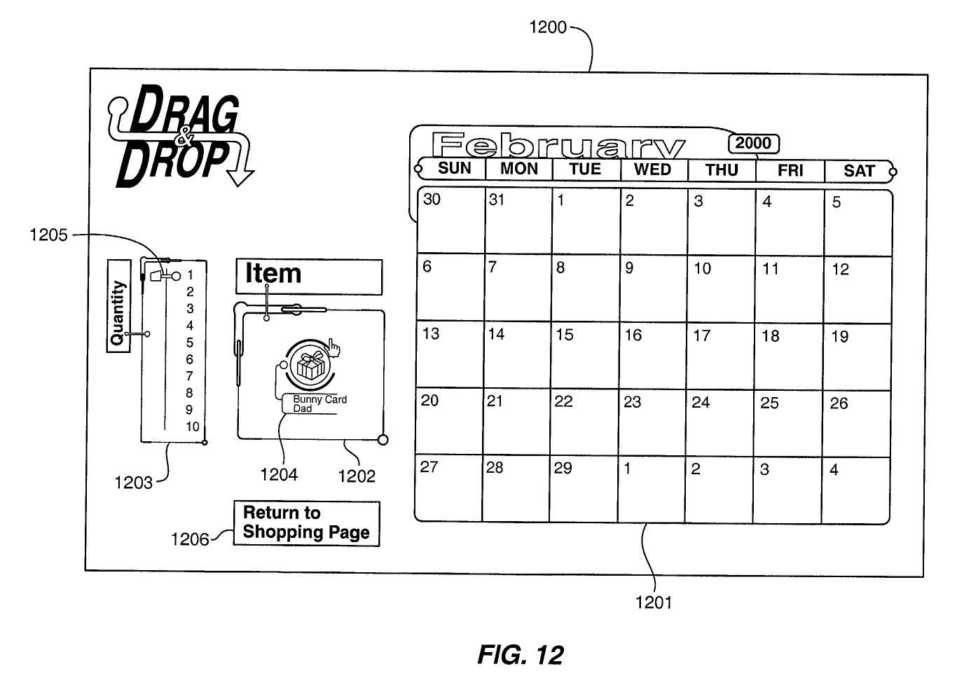

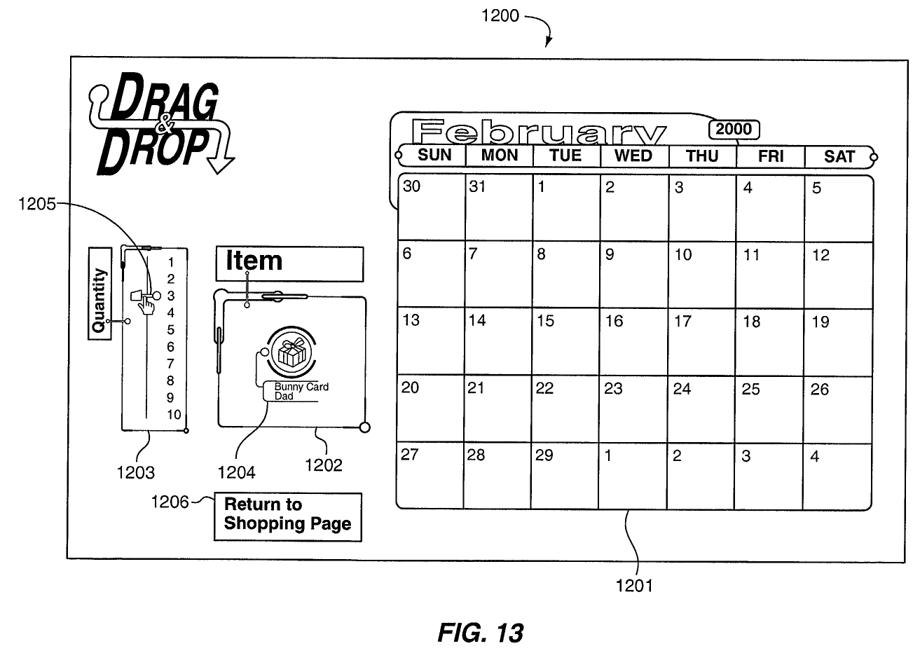

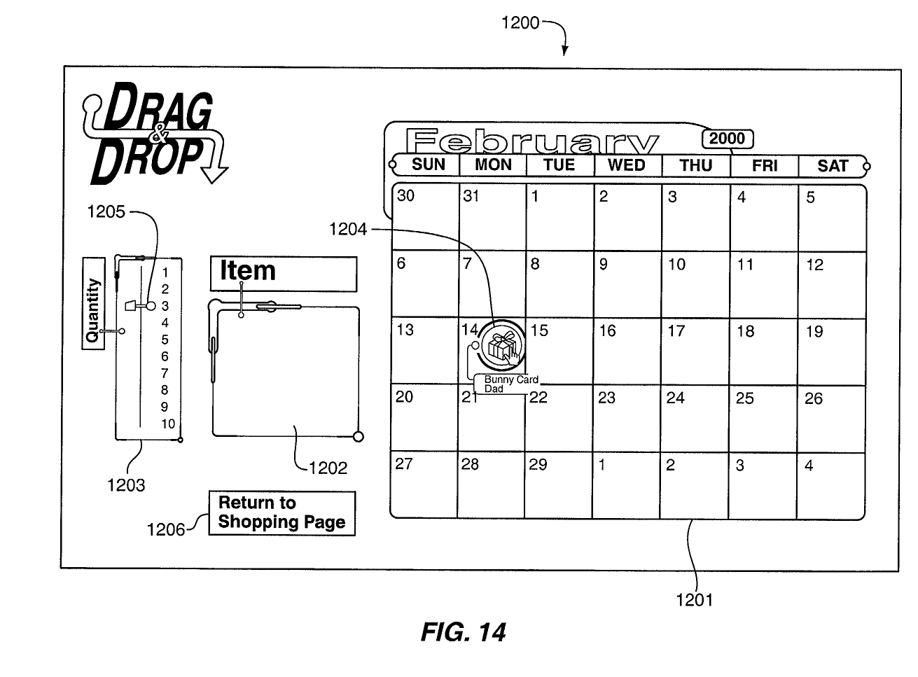

Once the customer clicks on a product icon 1001 and drags the product icon 1001 to an address book entry 1022, the drag-and-drop WEB site navigation system 10 updates the Customer 123 and Customer Order 128A Databases to reflect the customer's selection. The customer is then presented with a series of screens to complete this portion of the order. At step 402, the drag-and-drop WEB site navigation system 10 displays on screen 1200 of FIG. 12, the product, quantity data, item description data, and any other optional product selection data (such as color, size, price, etc.) that is required to complete the product selection. The customer can at step 403 enter the required order information, specifying the particulars of the product for the order. For example, the customer, as shown in FIG. 13 can select a quantity by placing the mouse pointer on the quantity icon and holding down the mouse button while dragging the quantity icon to the desired number. In the Interactive Voice Response interface instance, the customer drag-and-drop WEB site navigation system 10 responds to the customer's audible input that corresponds to the above-described point, click, drag and drop operations. A window shown in FIG. 14 then opens at step 404 to prompt the customer to select the desired shipping date by dragging the order icon 1204 onto a selected date displayed on the calendar 1201. In the Interactive Voice Response interface instance, the customer drag-and-drop WEB site navigation system 10 responds to the customer's audible input of the date. After the customer selects a shipping date, as determined at step 405, the calendar window 1200 closes and the drag-and-drop WEB site navigation system 10 updates the Customer Order 128A and Payment 128B Databases at step 406. Alternatively, the customer can select other products for purchase for this recipient or can select the same product for other recipients or can select other products for other recipients at this juncture before proceeding to the final order processing steps. The customer can accomplish this by clicking on the Return to Shopping Page icon 1206, which brings the customer back to the Shopping Page 600 illustrated in FIG. 10 to proceed at step 306 with additional purchases for selected recipients in this shopping session.

If the customer does not return to the Shopping Page 600, the drag-and-drop WEB site navigation system 10 opens a window (not shown) at step 407 to display payment options, retrieved from Payment Database 128B. The customer is asked at step 408 to enter or select the required information, which is then verified and submitted as an order transaction by the drag-and-drop WEB site navigation system 10 updating the Customer Order Database 128A at step 409.

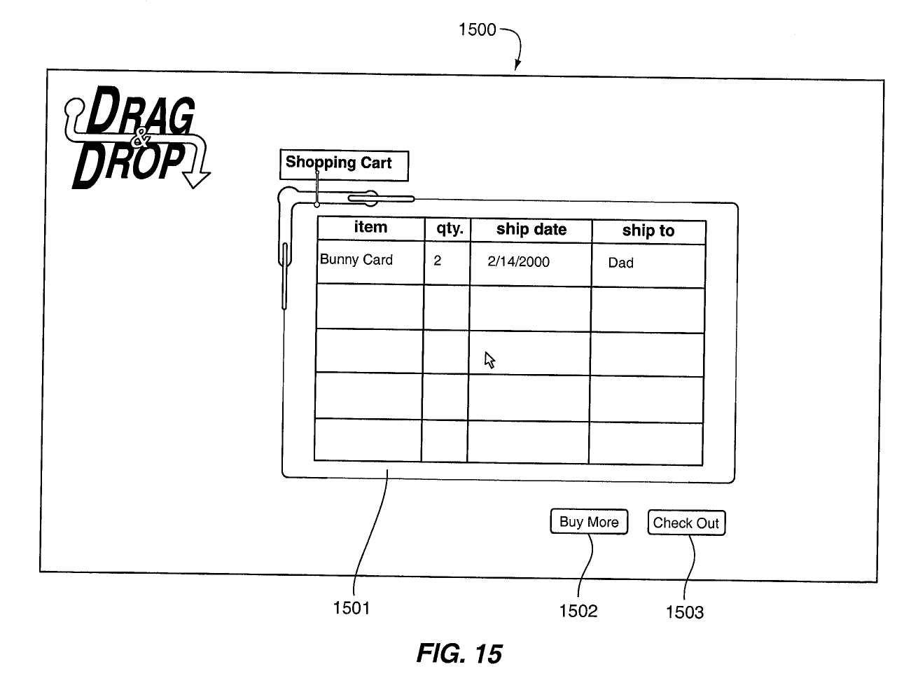

When the customer has finished shopping, the customer can elect to view the shopping cart as shown in FIG. 15 at step 501, which results in the shopping cart information being displayed at step 502. The customer can decide at step 503 to confirm the order by clicking on the “Check Out” button 1503 or speaking the phrase at step 504 to complete the transaction. However, after providing the order information, the customer can also continue shopping for other products for the same or different address book entries. Thus, if the customer does not elect to check out at step 503, processing advances to step 505 where the customer is presented with the option to return to step 208 and select a different shopping category, or to step 303 to select a different store, or can return to step 306 to display additional product descriptions in the presently selected store as described above.

Once the order(s) are confirmed, and the customer has clicked on the “Check Out” button 1503 at step 504 to complete the transaction, processing advances to step 506 where the customer is provided with the option to shop again from the site via step 507, or leave the site via step 508. If the customer elects to proceed with additional shopping in another store, the customer is presented with the option to return to step 208 and select a different shopping category, or to step 303 to select a different store.

In this check out process, there are a number of possible variations. The customer can be presented with an invoice on a per vendor basis, or can receive a single composite invoice for all purchases, or can receive an invoice on a per recipient basis, as selected by the customer pursuant to the check out process or identified in the customer profile. Therefore, the customer can return to different stores and shopping categories as described above, or can shop for all purchases in a single store, then check out from that store in steps 503-506 before shopping in other stores in the same shopping session. This variety of options are provided by the drag-and-drop WEB site navigation system 10 by enabling the customer to simply use the graphical user interface functions of point, click, drag and drop in whatever sequence the customer desires. Furthermore, the customer can terminate their session at any point and store the session data for later use in a follow up session where the customer completes the transaction.

### SUMMARY p The drag-and-drop WEB site navigation system implements a drag-and-drop paradigm that allows customers to easily select WEB merchants from a plurality of WEB merchants, browse the merchant's products, select product(s) for purchase, select a recipient from the customer's personal address book to receive product and purchase the product using the drag-and-drop mode of selection to perform each step of this process, to thereby minimize or eliminate the use of the keyboard of the terminal device.

What is claimed:

1. A drag-and-drop WEB site navigation system that enables a customer to shop for products from at least one vendor, where said customer, using a terminal device, communicates with an order fulfillment center via a communication network, said drag-and-drop WEB site navigation system comprising:
means for storing data in a memory that are indicative of at least one vendor and their products;
means for transmitting, to said terminal device for display thereon in graphical form, at least a portion of said data stored in said memory and indicative of at least one vendor and their products; and
means for enabling said customer, using said terminal device, to manipulate said data displayed in graphical form to generate a customer order to purchase at least one of said products from at least one of said at least one vendor.

2. The drag-and-drop WEB site navigation system of claim 1 wherein said means for enabling comprises:
means for transmitting, to said terminal device for display thereon in graphical form, recipient data indicative of at least one recipient; and
means for enabling said customer, using said terminal device, to drag at least one of said product data displayed in graphical form to drop on said recipient data displayed in graphical form to identify at least one recipient to receive said at least one of said products.

3. The drag-and-drop WEB site navigation system of claim 1 further comprising:
means for enabling said customer, using said terminal device, to transmit customer recipient data, indicative of at least one recipient associated with said customer, to said drag-and-drop WEB site navigation system; and
means for storing said received customer recipient data in a memory for use by said customer.

4. The drag-and-drop WEB site navigation system of claim 3 wherein said means for enabling comprises:
means for transmitting, to said terminal device for display thereon in graphical form, at least a portion of said customer recipient data retrieved from said means for storing recipient data and indicative of at least one recipient; and
means for enabling said customer, using said terminal device, to drag at least one of said product data displayed in graphical form to drop on said recipient data displayed in graphical form to identify at least one recipient to receive said at least one of said products.

5. The drag-and-drop WEB site navigation system of claim 1 wherein said means for storing data comprises:
means for storing data comprising at least one of: Internet link address for at least one vendor's WEB site, product identifications, product identifications sorted by product categories, product descriptions, and the like.

6. The drag-and-drop WEB site navigation system of claim 1 further comprising:
means for transmitting, to said terminal device for display thereon in graphical form, data indicative of a plurality of shopping categories; and
means, responsive to said customer selecting a one of said displayed shopping categories, for sorting said data stored in said memory indicative of at least one vendor to generate a list of vendors comprising said at least a portion of said data.

7. The drag-and-drop WEB site navigation system of claim 6 further comprising:
means for transmitting, to said terminal device for display thereon in graphical form, data indicative of said list of vendors; and
means, responsive to said customer selecting a one of said displayed at least one vendor, for sorting said product data stored in said memory and indicative of products sold by said selected vendor to generate a list of products comprising said at least a portion of said data.

8. The drag-and-drop WEB site navigation system of claim 7 wherein said means for enabling comprises:
means for transmitting, to said terminal device for display thereon in graphical form, recipient data indicative of at least one recipient; and
means for enabling said customer, using said terminal device, to drag at least one of said product data displayed in graphical form to drop on said recipient data displayed in graphical form to identify at least one recipient to receive said at least one of said products.

9. The drag-and-drop WEB site navigation system of claim 1 further comprising:
means for displaying data to said customer indicative of said at least one recipient selected to receive said at least one of said products; and
means for receiving data from said customer to order said at least one of said products for said at least one recipient.

10. The drag-and-drop WEB site navigation system of claim 9 further comprising:
means for displaying data to said customer indicative of said at least one method of payment to purchase said at least one of said products;
means for receiving data from said customer indicative of a selected one of said at least one method of payment to purchase said at least one of said products for said at least one recipient; and
means, responsive to receipt of said data indicative of a selected one of said at least one method of payment, for executing said customer order to deliver said goods to said at least one recipient.

11. The drag-and-drop WEB site navigation system of claim 9 further comprising:
means for displaying data to said customer indicative of said at least one date for said at least one recipient to receive said at least one of said products;
means for receiving data from said customer to select a one of said at least one of said dates; and
means, responsive to receipt of said data indicative of a selected date, for executing said customer order to deliver said goods to said at least one recipient by said selected date.

12. The drag-and-drop WEB site navigation system of claim 1 further comprising:
means, responsive to said customer communicating with said order fulfillment center via said communication network, for providing said customer terminal device with a login data entry screen; and
means, responsive to login data transmitted from said customer terminal device, for confirming that said received data matches customer authentication data stored in said memory.

13. The drag-and-drop WEB site navigation system of claim 1 wherein said means for enabling comprises:
means for transmitting, to said terminal device for display thereon in graphical form, data indicative of at least one choice provided to said customer; and means for enabling said customer, using said terminal device, to provide audible input to select at least one of said at least one choice.

14. A method of operating a drag-and-drop WEB site navigation system that enables a customer to shop for products from at least one vendor, where said customer, using a terminal device, communicates with an order fulfillment center via a communication network, said drag-and-drop WEB site navigation system comprising the steps of:
storing data in a memory that are indicative of at least one vendor and their products;
transmitting, to said terminal device for display thereon in graphical form, at least a portion of said data stored in said memory and indicative of at least one vendor and their products; and
enabling said customer, using said terminal device, to manipulate said data displayed in graphical form to generate a customer order to purchase at least one of said products from at least one of said at least one vendor.

15. The method of operating a drag-and-drop WEB site navigation system of claim 14 wherein said step of enabling comprises:
transmitting, to said terminal device for display thereon in graphical form, recipient data indicative of at least one recipient; and
enabling said customer, using said terminal device, to drag at least one of said product data displayed in graphical form to drop on said recipient data displayed in graphical form to identify at least one recipient to receive said at least one of said products.

16. The method of operating a drag-and-drop WEB site navigation system of claim 14 further comprising the steps of:
enabling said customer, using said terminal device, to transmit customer recipient data, indicative of at least one recipient associated with said customer, to said drag-and-drop WEB site navigation system; and
storing said received customer recipient data in a memory for use by said customer.

17. The method of operating a drag-and-drop WEB site navigation system of claim 16 wherein said step of enabling comprises:
transmitting, to said terminal device for display thereon in graphical form, at least a portion of said customer recipient data retrieved from said memory and indicative of at least one recipient; and
enabling said customer, using said terminal device, to drag at least one of said product data displayed in graphical form to drop on said recipient data displayed in graphical form to identify at least one recipient to receive said at least one of said products.

18. The method of operating a drag-and-drop WEB site navigation system of claim 14 wherein said step of storing data comprises:
storing data comprising at least one of: Internet link address for at least one vendor's WEB site, product identifications, product identifications sorted by product categories, product descriptions, and the like.

19. The method of operating a drag-and-drop WEB site navigation system of claim 14 further comprising the steps of:
transmitting, to said terminal device for display thereon in graphical form, data indicative of a plurality of shopping categories; and
sorting, in response to said customer selecting a one of said displayed shopping categories, said data stored in said memory indicative of at least one vendor to generate a list of vendors comprising said at least a portion of said data.

20. The method of operating a drag-and-drop WEB site navigation system of claim 19 further comprising the steps of:
transmitting, to said terminal device for display thereon in graphical form, data indicative of said list of vendors; and
sorting, in response to said customer selecting a one of said displayed at least one vendor, said product data stored in said memory and indicative of products sold by said selected vendor to generate a list of products comprising said at least a portion of said data.

21. The method of operating a drag-and-drop WEB site navigation system of claim 20 wherein said step of enabling comprises:
transmitting, to said terminal device for display thereon in graphical form, recipient data indicative of at least one recipient; and
enabling said customer, using said terminal device, to drag at least one of said product data displayed in graphical form to drop on said recipient data displayed in graphical form to identify at least one recipient to receive said at least one of said products.

22. The method of operating a drag-and-drop WEB site navigation system of claim 14 further comprising the steps of:
displaying data to said customer indicative of said at least one recipient selected to receive said at least one of said products; and
receiving data from said customer to order said at least one of said products for said at least one recipient.

23. The method of operating a drag-and-drop WEB site navigation system of claim 22 further comprising the steps of:
displaying data to said customer indicative of said at least one method of payment to purchase said at least one of said products;
receiving data from said customer indicative of a selected one of said at least one method of payment to purchase said at least one of said products for said at least one recipient; and
executing, in response to receipt of said data indicative of a selected one of said at least one method of payment, said customer order to deliver said goods to said at least one recipient.

24. The method of operating a drag-and-drop WEB site navigation system of claim 22 further comprising the steps of:
displaying data to said customer indicative of said at least one date for said at least one recipient to receive said at least one of said products;
receiving data from said customer to select a one of said at least one of said dates; and
executing, in response to receipt of said data indicative of a selected date, said customer order to deliver said goods to said at least one recipient by said selected date.

25. The method of operating a drag-and-drop WEB site navigation system of claim 14 further comprising the steps of:
providing, in response to said customer communicating with said order fulfillment center via said communication network, said customer terminal device with a login data entry screen; and
confirming, in response to login data transmitted from said customer terminal device, that said received data matches customer authentication data stored in said memory.

26. The method of operating a drag-and-drop WEB site navigation system of claim 14 wherein said step of enabling comprises:
transmitting, to said terminal device for display thereon in graphical form, data indicative of at least one choice provided to said customer; and
enabling said customer, using said terminal device, to provide audible input to select at least one of said at least one choice.

27. A drag-and-drop WEB site navigation system that enables a customer to shop for products from at least one vendor, where said customer, using a terminal device, communicates with an order fulfillment center via a communication network, said drag-and-drop WEB site navigation system comprising:
database memory means for storing data in a memory that are indicative of at least one vendor and their products;
shopping page means for transmitting, to said terminal device for display thereon in graphical form, at least a portion of said data stored in said memory and indicative of at least one vendor and their products; and
drag and drop means for enabling said customer, using said terminal device, to manipulate said data displayed in graphical form to generate a customer order to purchase at least one of said products from at least one of said at least one vendor.

28. The drag-and-drop WEB site navigation system of claim 27 wherein said drag and drop means comprises:
address data means for transmitting, to said terminal device for display thereon in graphical form, recipient data indicative of at least one recipient; and
recipient selection means for enabling said customer, using said terminal device, to drag at least one of said product data displayed in graphical form to drop on said recipient data displayed in graphical form to identify at least one recipient to receive said at least one of said products.

29. The drag-and-drop WEB site navigation system of claim 27 further comprising:
gateway means for enabling said customer, using said terminal device, to transmit customer recipient data, indicative of at least one recipient associated with said customer, to said drag-and-drop WEB site navigation system; and
address database means for storing said received customer recipient data in a memory for use by said customer.

30. The drag-and-drop WEB site navigation system of claim 29 wherein said gateway means comprises:
address data means for transmitting, to said terminal device for display thereon in graphical form, at least a portion of said customer recipient data retrieved from said means for storing recipient data and indicative of at least one recipient; and
recipient selection means for enabling said customer, using said terminal device, to drag at least one of said product data displayed in graphical form to drop on said recipient data displayed in graphical form to identify at least one recipient to receive said at least one of said products.

31. The drag-and-drop WEB site navigation system of claim 27 wherein said memory means comprises:
database means for storing data comprising at least one of: Internet link address for at least one vendor's WEB site, product identifications, product identifications sorted by product categories, product descriptions, and the like.

32. The drag-and-drop WEB site navigation system of claim 27 further comprising:
category section means for transmitting, to said terminal device for display thereon in graphical form, data indicative of a plurality of shopping categories; and
vendor database sorting means, responsive to said customer selecting a one of said displayed shopping categories, for sorting said data stored in said memory indicative of at least one vendor to generate a list of vendors comprising said at least a portion of said data.

33. The drag-and-drop WEB site navigation system of claim 32 further comprising:
vendor section means for transmitting, to said terminal device for display thereon in graphical form, data indicative of said list of vendors; and
product database sorting means, responsive to said customer selecting a one of said displayed vendors, for sorting said product data stored in said memory and indicative of products sold by said selected vendor to generate a list of products comprising said at least a portion of said data.

34. The drag-and-drop WEB site navigation system of claim 33 wherein said means for enabling comprises:
address section means for transmitting, to said terminal device for display thereon in graphical form, recipient data indicative of at least one recipient; and
order initiation means for enabling said customer, using said terminal device, to drag at least one of said product data displayed in graphical form to drop on said recipient data displayed in graphical form to identify at least one recipient to receive said at least one of said products.

35. The drag-and-drop WEB site navigation system of claim 27 further comprising:
shopping cart means for displaying data to said customer indicative of said at least one recipient selected to receive said at least one of said products; and
order detail means for receiving data from said customer to order said at least one of said products for said at least one recipient.

36. The drag-and-drop WEB site navigation system of claim 35 further comprising:
payment means for displaying data to said customer indicative of said at least one method of payment to purchase said at least one of said products;
purchase authorization means for receiving data from said customer indicative of a selected one of said at least one method of payment to purchase said at least one of said products for said at least one recipient; and
order completion means, responsive to receipt of said data indicative of a selected one of said at least one method of payment, for executing said customer order to deliver said goods to said at least one recipient.

37. The drag-and-drop WEB site navigation system of claim 36 further comprising:
calendar means for displaying data to said customer indicative of said at least one date for said at least one recipient to receive said at least one of said products;
date selection means for receiving data from said customer to select a one of said at least one of said dates; and
order completion means, responsive to receipt of said data indicative of a selected date, for executing said customer order to deliver said goods to said at least one recipient by said selected date.

38. The drag-and-drop WEB site navigation system of clam 27 further comprising:
means, responsive to said customer communicating with said order fulfillment center via said communication network, for providing said customer terminal device with a login data entry screen; and
means, responsive to login data transmitted from said customer terminal device, for confirming that said received data matches customer authentication data stored in said memory.
